(19) United States
(12) Patent Application Publication
(10) Pub. No.: US 2003/0007518 A1
(43) Pub. Date: Jan. 9, 2003

(54) Multilayer multiplexing for generating an MPEG2 transport stream from elementary MPEG2 and MPEG4 streams

(76) Inventors: Myrian C. Amielh-Caprioglio, Paris (FR); Thierry Planterose, Paris (FR); Cyrille Christophe Morel, Paris (FR)

Correspondence Address: U.S. Philips Corporation, 580 White Plains Road, Tarrytown, NY, 10591, US

(21) Appl. No.: 10/180,601

(22) Filed: Jun. 26, 2002

(30) Foreign Application Priority Data
Jun. 26, 2001 (FR) 0108422

(51) Int. Cl. H04J 1/16

(52) U.S. Cl. 370/537; 370/216

(57) ABSTRACT

The invention relates to a transmitter comprising a multilayer multiplexing device for generating an output stream having an output rate, multiplexed from elementary input streams having elementary rates, the multilayer multiplexing device comprising at least a first, master multiplexer and, subsequent thereto, a second, slave multiplexer, the master multiplexer receiving an input stream, referred to as multiplexed input stream at at least one input, multiplexed by the slave multiplexer from at least a first and a second elementary input stream, and a third elementary input stream at at least a second input, the master multiplexer having means for controlling said output rate so as to guarantee a predetermined minimum average output rate.

The invention relates to digital transmissions in general and, more particularly, to the part for multiplexing data in a digital telecommunication system. The invention is particularly applicable in a transmitter comprising a multilayer multiplexing device for generating an output stream having an output rate, multiplexed from the elementary input streams having elementary rates.

The invention also relates to a server comprising such a transmitter and a system comprising such a server. It also relates to a multilayer multiplexing method, a computer program and a signal for transporting said program.

The invention finds numerous applications, notably in interactive digital television systems in accordance with the MPEG2 and MPEG4 standards.

The transport of data of the MPEG4 type in a transport stream of the MPEG2 type is described in the document ISO/IEC JTC1/SC29/WG11/N3050 published by ISO (International Standardization Organization) in January 2000, entitled “Information Technology—Generic Coding of Moving Pictures and Audio: Systems; Amendment 7: Transport of ISO/IEC 14496 data over ISO/IEC 13818-1”.

It is an object of the invention to provide advantageous means for transporting, in an output stream having a given output rate, elementary streams having elementary rates, multiplexed in accordance with a multilayer multiplexing method. For example, a first multiplexing operation is performed between two correlated elementary streams and a second multiplexing operation is performed between this pre-multiplexed stream and other elementary streams. The invention provides the possibility of guaranteeing the output rate of the stream in the final transport.

To this end, a transmitter is described, which comprises a multilayer multiplexing device for generating an output stream having an output rate, multiplexed from elementary input streams having elementary rates, the multilayer multiplexing device comprising at least a first, master multiplexer and, subsequent thereto, a second, slave multiplexer, the master multiplexer receiving a first elementary stream at at least one first input and a multiplexed stream at at least a second input, supplied at the output of the slave multiplexer from at least a second elementary input stream, the master multiplexer having means for controlling said output rate so as to guarantee a predetermined minimum average output rate as a function of said elementary rates.

In accordance with an important characteristic feature of the invention, said means for controlling the output rate comprise a device constituted by virtual buffer memories associated with the input streams of the multiplexers. The virtual buffer memories have filling speeds associated with the rates of said associated input streams, such that when a buffer memory associated with an elementary stream at the input of the master multiplexer is full, a packet of data is created in the output stream from data extracted from said associated elementary stream, and when a buffer memory associated with a multiplexed input stream at the input of the master multiplexer is full, a packet of data is created in the output flux from the data extracted from the elementary stream at the input of the slave multiplexer which, among the elementary input streams of the slave multiplexer, is associated with that buffer memory which is the first to be full.

In accordance with another characteristic feature of the invention, the multiplexers have local clocks for locally synchronizing the input streams from local time bases associated with said multiplexers. The means for controlling the output rate comprise global synchronizing means having a local master clock associated with the master multiplexer, a local slave clock associated with the slave multiplexer and means for controlling the synchronization of the slave clock with the master clock.

These and other aspects of the invention are apparent from and will be elucidated, by way of non-limitative example, with reference to the embodiment(s) described hereinafter.

In the drawings:

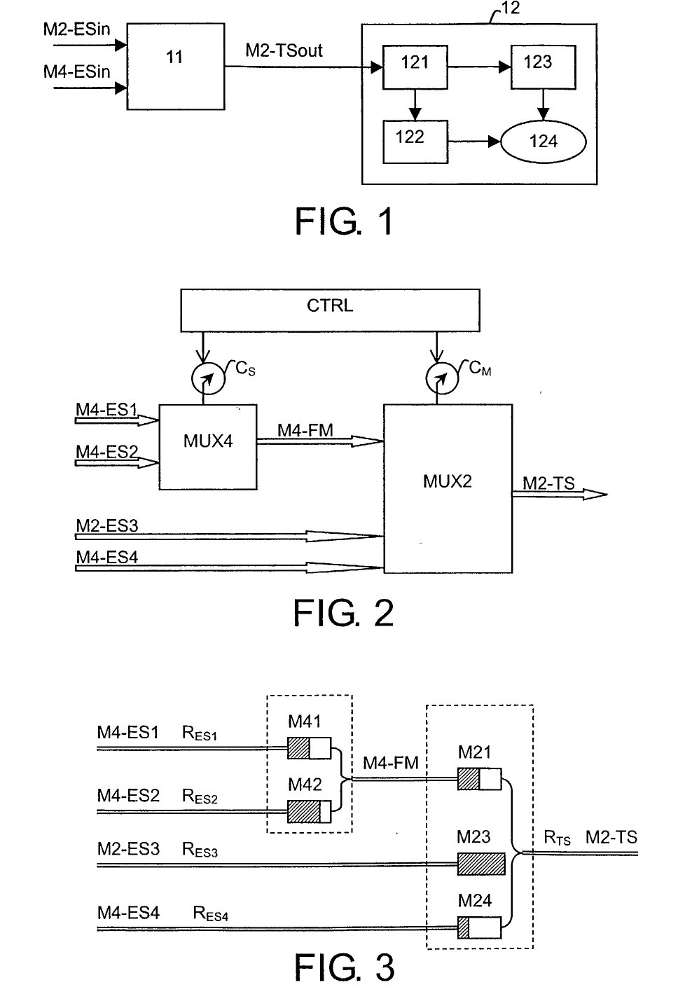

FIG. 1 is a diagram showing an example of the digital transmission system according to the invention.

FIG. 2 is a functional diagram showing an example of the multiplexing device according to the invention.

FIG. 3 is a principal circuit diagram for illustrating the operation of an embodiment of a multilayer multiplexer according to the invention.

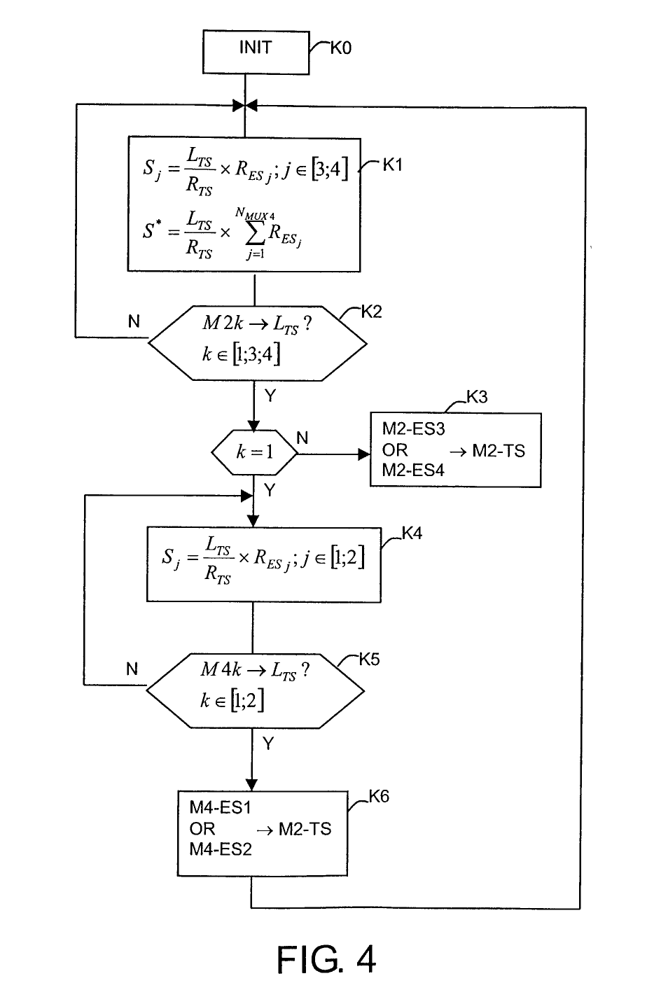

FIG. 4 is a flow chart illustrating a multilayer multiplexing method according to the invention.

The following description illustrates an example of using the invention for generating an output stream of the MPEG2 transport stream type incorporating data of the MPEG4 type in accordance with amendment 7 of the MPEG2 standard as described in the document ISO/IEC JTC1/SC29/WG11/N3050 published by ISO (International Standardization Organization) in January 2000, entitled “Information Technology—Generic Coding of Moving Pictures and Audio: Systems; Amendment 7: Transport of ISO/IEC 14496 data over ISO/IEC 13818-1”. In accordance with this example, the output stream is obtained from the elementary input streams of the MPEG2 or MPEG4 type, and at least a stream of data of the MPEG4 type multiplexed from two elementary streams of the MPEG4 type by a standardized multiplexer of the “Flex Mux” type. The Flex Mux multiplexer is described in the document of the MPEG4 standard, Systems ISO/IEC 14496-1 Information Technologies—Coding of audiovisual Objects, Part 1: Systems, 1999. The invention is not limited to this particular application. The invention may particularly be used to advantage in applications involving multilayer multiplexing. Examples of such applications are interactive television applications for digital decoders of the set top box type, interactive applications for portable multimedia apparatus, applications involving the creation of digital content and applications using the MPEG7 standard.

FIG. 1 illustrates a digital television system according to the invention. This system comprises a server 11 for generating, from the elementary input streams of the MPEG2 type, M2-ESin, or MPEG4 type, M4-ESin, representing video programs, an output stream of the MPEG2 transport stream type, M2-TSout, transporting data of the MPEG2 and MPEG4 types coming from elementary input streams. The system also includes a terminal 12 comprising a demultiplexing block 121, an MPEG4 decoder 122 and a MPEG2 decoder 123 for recovering the multimedia data with a view to their use in a client application 124.

In accordance with the MPEG2 standard, information about the stream is transmitted in the form of PSI (Program System Information) tables. This information indicates how the stream is constituted. It gives information about the number and type (MPEG2 audio, MPEG4 audio, MPEG2 video, MPEG4 video, etc.) of the transported elementary streams. In the output stream, which is an MPEG2 transport stream, all of these different streams with their different data are multiplexed before their transmission by the server 11 with the aid of a multiplexing device in the server. The PSI tables allow reconstitution of the programs associated with the different elementary streams at the receiving end.

FIG. 2 is a block diagram of a multilayer multiplexing device according to the invention, which can be used in the server 11 of FIG. 1 or, more generally, in a transmitter intended to transmit multiplexed digital data to a terminal. It comprises a master multiplexer MUX2 operating in accordance with a time base or master clock CM, a slave multiplexer MUX4 operating in accordance with a time base or slave clock Cs, and a device CTRL for controlling the output rate. The slave multiplexer MUX4 is a multiplexer of the Flex Mux MPEG4 type. It is used for multiplexing elementary streams of the MPEG4 type, M4-ES 1 and M4-ES2, which are mutually correlated. Advantageously, these streams transport video programs of the MPEG4 type relating to the same basic program of the MPEG4 type. Their multiplexing prior to transport in an MPEG2 transport stream allows improvement of the performance of the subsequent demultiplexing operation. The output of the slave multiplexer MUX4 is a stream of multiplexed packets M4-FM comprising multiplexed data of the MPEG4 type belonging to two distinct elementary streams. The master multiplexer MUX2 is a multiplexer of the MPEG2 type which is capable of receiving elementary streams of the MPEG2 and MPEG4 type. The way in which the multiplexer MUX2 can encapsulate data of the MPEG4 type in an MPEG2 transport stream is described in amendment 7 of the above-cited MPEG2 standard. In the example described and illustrated in FIGS. 2 to 4, the multiplexer MUX2 receives the stream of multiplexed packets M4-FM at the input, as well as two elementary streams, M2-ES3 and M4-ES4 comprising data of the MPEG2 and MPEG4 type, respectively. It supplies a transport stream of the MPEG2 type, M2-TS, at the output, transporting the data of all the multiplexed input streams. The number of multiplexed streams in the example is limited for the sake of clarity, but the invention is applicable irrespective of the number of elementary or pre-multiplexed input streams. The rate of the output stream M2-TS is guaranteed by the control device CTRL.

The control device CTRL comprises a device for managing the double multiplexing layer for managing the multiplexing of data in the output stream from elementary input streams, and a device for synchronized managing of the time bases C_{S} and C_{M} associated with each multiplexer. The multiplexers comprise local clocks for locally synchronizing the input streams with respect to local time bases associated with said multiplexers. The means CTRL for controlling the output rate comprise means for globally synchronizing the local master clock associated with the master multiplexer with the local slave clock associated with the slave multiplexer, using control means for controlling the synchronization of the slave clock with the master clock.

In accordance with a preferred embodiment of the invention, shown in FIG. 3, the device for managing the double multiplexing layer is a device comprising virtual buffer memories M21, M22, M23, M41 and M42 associated with the input streams of the multiplexers. The virtual buffer memories are virtual objects which only exist through two values, for example, one representing their filling rate and the other representing their filling speed, or one representing their size and the other representing their filling rate. In accordance with the first definition, the filling speeds depend on the rates of the associated input streams. When a buffer memory M23 or M24, associated with the elementary stream at the input of the master multiplexer MUX2 is full, a packet of data is created in the output stream M2-TS from data extracted from said associated elementary stream M2-ES3 or M2-ES4. When a buffer memory associated with a multiplexed input stream M4-FM at the input of the master multiplexer MUX2 is full, a packet of data is created in the output stream M2-TS from data extracted from the elementary stream M4-ES1 or M4-ES2 at the input of the slave multiplexer MUX4 which, among the elementary input streams of the slave multiplexer, is associated with that buffer memory M41 or M42 which is the first to be full.

In accordance with a preferred embodiment of the invention, the device for synchronized managing of the time bases C_{S} and C_{M} associated with each multiplexer comprises a clock manager for controlling the two clocks C_{S} and C_{M} in the manner described below. The master clock C_{M} is a continuous clock which regulates the output traffic of the master multiplexer in the output stream M2-TS. A multiplexing cycle which consists of filling the memories of the master multiplexer MUX2 is referred to as primary or master multiplexing cycle, and a multiplexing cycle which consists of filling the memory of the slave multiplexer is referred to as secondary or slave multiplexing cycle. The slave multiplexer has its own clock C_{S} which is controlled by the master clock C_{M} through the clock manager, which may freeze, re-initialize or put it back on its route again in accordance with the following algorithm:

at the initial instant T=0 of the master clock C_{M}, the slave clock C_{S} is frozen,

at each primary (or master) multiplexing cycle,

the master clock C_{M} is updated,

when a virtual buffer memory associated with a stream multiplexed at the output of the slave multiplexer MUX4 is full,

the slave clock C_{S} is put back on its route,

its value is updated with the value of the master clock CM,

the slave multiplexer MUX4 is triggered so that at each secondary (or slave) multiplexing cycle, the value of the slave clock C_{S} is updated.

The operation of the control device CTRL shown in FIG. 3 will now be described in greater detail. Assuming that the packets transported in the output stream have a useful size of L_{TS} bits, the size of the virtual buffer memories may be fixed, for example, at L_{TS} bits. Whenever a virtual buffer memory is full, a packet of data having a length which is smaller than or equal to L_{TS} may be created in the output stream M2-TS in this way, the size of the packet depending on possible headers which must be added to the transported useful data. To guarantee a predetermined minimum average output rate, the buffer memories are filled at speeds having a proportional relationship with the rates of the input streams with which they are associated. The binary rate of the output stream M2-TS is denoted R_{TS} and the binary rates of the elementary streams M4-ES 1, M4-ES2, M2-ES3 and M4-ES4 are denoted R_{ESj}, with j=1, 2, 3 or 4, respectively. For each master or slave multiplexing cycle, the virtual buffer memories M41, M42, M23 and M24 are filled with a number of bits denoted Sj, with j=1 to 4, respectively. We have:

$${S}_{j} = \frac{{L}_{TS}}{{R}_{TS}} \times {R}_{{ES}_{j}} \qquad ( 1 )$$

On the other hand, the virtual memory M21 associated with the multiplexed input stream M4-FM is filled at each master multiplexing cycle with a number of bits denoted S* defined by the following equation:

$${S}^{*} = \frac{{L}_{TS}}{{R}_{TS}} \times {\sum }_{j = 1}^{{N}_{MUX 4}} {R}_{{ES}_{j}} \qquad ( 2 )$$

where N_{MUX4} represents the number of elementary streams at the input of the slave multiplexer MUX4 and where the sign Σ represents the sum of the binary rates of the elementary streams at the input of the slave multiplexer.

FIG. 4 illustrates the steps of an embodiment of a multilayer multiplexing method according to the invention for multiplexing, in an output stream having an output rate, data transported in elementary input streams having elementary rates, and data transported in at least an input stream having an input rate, referred to as multiplexed rate, multiplexed from elementary streams having elementary rates. The method particularly comprises a step of controlling the output rate for guaranteeing a predetermined minimum average output rate. The step of controlling the output rate comprises the following sub-steps:

an initialization INIT step K0 for initializing the means for controlling the output rate, these means comprising a set of virtual buffer memories having a filling rate and filling speeds determined as a function of the elementary input rates,

a primary cyclic step K1 of filling the buffer memories associated with the input streams of the master multiplexer, also referred to as master multiplexing step, such that, during a primary filling cycle, the filling rate of the virtual buffer memories associated with the input streams of the master multiplexer increases in accordance with the determined filling speeds,

a primary detection step K2 for detecting whether a virtual buffer memory associated with an input stream of the master multiplexer is full,

if the buffer memory detected to be full is associated with an elementary input stream of the master multiplexer (Y; N), a primary step K3 of creating data in the output stream from data extracted from said elementary input stream,

if the buffer memory detected to be full is associated with a multiplexed input stream of the master multiplexer (Y; Y), a secondary cyclic step K4 of filling the buffer memories associated with the input streams of the slave multiplexer, also referred to as slave multiplexing step, such that, during a secondary filling cycle, the filling rate of the virtual buffer memories increases in accordance with the determined filling speeds,

a secondary detection step K5 for detecting whether a virtual buffer memory associated with an input stream of the slave multiplexer is full,

when a virtual buffer memory associated with an input stream of the slave multiplexer is detected to be full (Y), a secondary step K6 of creating data in the output stream from data extracted from the elementary input stream of the slave multiplexer associated with the virtual buffer memory that is detected to be full.

The filling speeds of the virtual buffer memories are determined as a function of the rates of the input streams associated with the memories in accordance with the equations (1) and (2) which express the number of bits with which the memories are filled at each filling cycle.

The method described above is preferably realized with the aid of a computer program comprising program code instructions for performing the steps of the method when the program is executed by a processor situated, for example, in a transmitter associated with a digital television server for transmitting data to a distant digital television terminal.

Embodiments of a transmitter and a digital television server, a digital telecommunication system and a multiplexing method which may be realized in a transmitter for transmitting data to a digital television terminal have been described and illustrated by way of example. Other embodiments may easily be derived from the described embodiments without departing from the scope of the invention. Particularly, the number of input streams and slave multiplexers is not limited.

1. A transmitter comprising a multilayer multiplexing device for generating an output stream having an output rate, multiplexed from elementary input streams having elementary rates, the multilayer multiplexing device comprising at least a first, master multiplexer and, subsequent thereto, a second, slave multiplexer, the master multiplexer receiving a first elementary stream at at least one first input and a multiplexed stream at at least a second input, supplied at the output of the slave multiplexer from at least a second elementary input stream, the master multiplexer having means for controlling said output rate so as to guarantee a predetermined minimum average output rate as a function of said elementary rates.

2. A transmitter as claimed in claim 1, wherein said means for controlling the output rate comprise a device constituted by virtual buffer memories associated with the input streams of the multiplexers, the virtual buffer memories having filling speeds associated with the rates of said associated input streams, such that when a buffer memory associated with an elementary stream at the input of the master multiplexer is full, a packet of data is created in the output stream from data extracted from said associated elementary stream, and when a buffer memory associated with a multiplexed stream at the input of the master multiplexer is full, a packet of data is created in the output flux from the data extracted from the elementary stream at the input of the slave multiplexer which, among the elementary input streams of the slave multiplexer, is associated with that buffer memory which is the first to be full.

3. A transmitter as claimed in claim 1, wherein the multiplexers have local clocks for locally synchronizing the input streams from local time bases associated with said multiplexers, and wherein said means for controlling the output rate comprise global synchronizing means having a local master clock associated with the master multiplexer, a local slave clock associated with the slave multiplexer and means for controlling the synchronization of the slave clock with the master clock.

4. A server in a digital telecommunication system, comprising a transmitter as claimed in any one of claim 1.

5. A digital telecommunication system comprising a server as claimed in claim 4 and a client terminal intended to receive the output stream supplied by the transmitter and to recover the data transported in said output stream so as to use them in a client application.

6. A multilayer multiplexing method of multiplexing, in an output stream having an output rate, data transported in elementary input streams having elementary rates, and data transported in at least a multiplexed input stream having an input rate referred to as multiplexed rate from elementary streams having elementary rates, the method comprising a step of controlling the output rate for guaranteeing a predetermined minimum average output rate.

7. A method as claimed in claim 6, wherein the step of controlling the output rate comprises the following sub-steps:
an initialization step for initializing the means for controlling the output rate, these means comprising a set of virtual buffer memories having a filling rate and filling speeds determined as a function of the elementary input rates,
a primary cyclic step of filling the buffer memories associated with the input streams of the master multiplexer, such that, during a primary filling cycle, the filling rate of the virtual buffer memories increases in accordance with the determined filling speeds,
a primary detection step for detecting whether a virtual buffer memory associated with an input stream of the master multiplexer is full,
if the buffer memory detected to be full is associated with an elementary input stream of the master multiplexer, a primary step of creating data in the output stream from data extracted from said elementary input stream, if the buffer memory detected to be full is associated with a multiplexed input stream of the master multiplexer, a secondary cyclic step of filling the buffer memories associated with the input streams of the slave multiplexer, such that, during a secondary filling cycle, the filling rate of the virtual buffer memories increases in accordance with the determined filling speeds,
a secondary detection step for detecting whether a virtual buffer memory associated with an input stream of the slave multiplexer is full,
when a virtual buffer memory associated with an input stream of the slave multiplexer is detected to be full, a secondary step of creating data in the output stream from data extracted from the elementary input stream of the slave multiplexer associated with the virtual buffer memory that is detected to be full.

8. A computer program comprising program code instructions for performing the steps of the method as claimed in claim 6, when said program is executed by a processor, notably in a transmitter as claimed in any one of claims 1 to 3.

9. A signal for transporting a computer program as claimed in claim 8.

10. A signal for transporting, in an output stream having an output rate, data originating from the elementary input streams having elementary input rates, the signal being obtained by means of the method as claimed in claim 6.
